(19) United States
(12) Patent Application Publication
(10) Pub. No.: US 2026/0093845 A1
(43) Pub. Date: Apr. 2, 2026

(54) PRIVACY-ENHANCING GENERATION ON PRE-TRAINED GENERATIVE MODELS

(71) Applicant: Robert Bosch GmbH, Stuttgart (DE)

(72) Inventors: Bochuan CAO, State College, PA (US); Sashidhar JAKKAMSETTI, Sunnyvale, CA (US); Jorge GUAJARDO MERCHAN, Pittsburgh, PA (US)

(21) Appl. No.: 18/903,651

(22) Filed: Oct. 1, 2024

(51) Int. Cl. G06F 21/62

(52) U.S. Cl. CPC G06F 21/6245

(57) ABSTRACT

Privacy-enhancing interaction with generative models is performed. Private input content is mixed with public input content to create a masked input, the mixing obfuscating the private input content. The masked input is sent to a server generative model for processing to receive a server result. The server result is received from the server generative model. The public input content is processed using a local generative model to generate a local result. The server result and the local result are combined to remove a contribution of the public input content from the server result, thereby resulting in a final output to the private input content.

### TECHNICAL FIELD

Aspects of the disclosure generally relate to privacy-enhancing generation on pre-trained generative models.

### BACKGROUND

Generative models, such as large language models (LLMs) and their generalizations such as multi-modal LLMs have achieved impressive success in many fields through training on vast amounts of text data. They have found widespread practical applications in finance, law, healthcare industry, and other domains. Among these, chat LLMs capable of real-time dialogue, such as ChatGPT, Claude, and Llama-chat, have garnered the most attention and usage. While aspects of the disclosure refers to LLMs, it should be understood that the disclosure applies to their generalizations Multi-Modal LLMs and more generally to generative AI models.

Privacy leakage in LLMs primarily stems from two sources: training data and context during use. A series of studies have addressed the issue of context leakage during LLM inference. These studies mostly employ Prompt Injection methods, which involve issuing new instructions to the LLM, such as requesting it to repeat previous content, to obtain information from the context.

Some studies have emerged to prevent privacy leakage from training data. These methods often use differential privacy techniques to remove personal information from training data. Thus, even if attackers successfully extract portions of the LLM's training data using the aforementioned attack methods, these data would not contain genuine private content.

However, existing research on protecting context privacy during LLM inference only considers scenarios where the attacker is the user, not where the attacker is potentially located at the LLM service provider.

### SUMMARY

In one or more illustrative examples, a method for privacy-enhancing interaction with generative models includes mixing private input content with public input content to create a masked input, the mixing obfuscating the private input content; sending the masked input for processing by a server generative model to receive a server result; receiving the server result from the server generative model; processing the public input content using a local generative model to generate a local result; and combining the server result and the local result to remove a contribution of the public input content from the server result, thereby resulting in a final output to the private input content.

In one or more illustrative examples, the method includes appending the final output to the private input content and repeating the mixing, sending, receiving, processing, combining, and appending until an end of output token is reached.

In one or more illustrative examples, the mixing of the private input content with the public input content includes using a hyperparameter a that controls, at a word embedding level, how much weight is given to the private input content versus the public input content.

In one or more illustrative examples, the mixing of the private input content with the public input content includes the addition and/or multiplication, to the output, of noise according to a probability distribution to preclude attempts to reverse the mixing.

In one or more illustrative examples, the noise is distributed according to a Gaussian distribution.

In one or more illustrative examples, the noise is distributed according to a uniform distribution.

In one or more illustrative examples, the server generative model is a model having greater computational ability and greater resource requirements as compared to the local generative model.

In one or more illustrative examples, the combining includes subtracting the local result from the server result utilizing a hyperparameter 3 that adjusts an influence of the local result on the server result.

In one or more illustrative examples, the combining includes performing an argmax operation to utilize token with highest logits.

In one or more illustrative examples, the method further includes performing the mixing, sending, receiving, processing, and combining a plurality of times with different public input content and the same private input content; and aggregating the results of the plurality of times to determine the final output, thereby increasing a possibility that tokens with largest logits after the aggregating are related the private input content.

In one or more illustrative examples, the client device is a robot including one or more sensors configured to measure aspects of a condition of a computer-controlled machine and one or more actuators configured to control operation of the computer-controlled machine according to actuator control commands, and the method further includes receiving the private input content from the one or more sensors; and controlling the one or more actuators based on the actuator control command determined based on the final output.

In one or more illustrative examples, a system for privacy-enhancing inferencing with generative models includes a client device comprising one or more hardware processors and one or more memories storing a local generative model and a mix algorithm, the client device being configured to execute instructions of the mix algorithm to perform operations including to mix private input content with public input content to create a masked input, the mix obfuscating the private input content; send the masked input for processing by a server generative model to receive a server result; receive the server result from the server generative model; process the public input content using the local generative model to generate a local result; and combine the server result and the local result to remove a contribution of the public input content from the server result, thereby resulting in a final output to the private input content.

In one or more illustrative examples, the client device is further configured to execute the instructions of the mix algorithm to perform operations including to append the final output to the private input content and repeat the mix, send, receive, process, combine, and append until an end of output token is reached.

In one or more illustrative examples, the mix of the private input content with the public input content includes using a hyperparameter a that controls, at a word embedding level, how much weight is given to the private input content versus the public input content.

In one or more illustrative examples, the mix of the private input content with the public input content includes the addition and/or multiplication, to the output, of noise according to a probability distribution to preclude attempts to reverse the mixing.

In one or more illustrative examples, the noise is distributed according to a Gaussian distribution.

In one or more illustrative examples, the noise is distributed according to a uniform distribution.

In one or more illustrative examples, the server generative model is a model having greater computational ability and greater resource requirements as compared to the local generative model.

In one or more illustrative examples, to combine includes to subtract the local result from the server result utilizing a hyperparameter 3 that adjusts an influence of the local result on the server result.

In one or more illustrative examples, to combine includes to perform an argmax operation to utilize token with highest logits.

In one or more illustrative examples, the client device is further configured to execute the instructions of the mix algorithm to perform operations including to perform the mix, send, receive, process, and combine a plurality of times with different public input content and the same private input content; and aggregate the results of the plurality of times to determine the final output, thereby increasing a possibility that tokens with largest logits after the aggregate are related the private input content.

In one or more illustrative examples, the system further includes a generative model service provider comprising one or more hardware processors and one or more memories storing the server generative model in communication over a communications network with the client device.

In one or more illustrative examples, the client device is a robot including one or more sensors configured to measure aspects of a condition of a computer-controlled machine and one or more actuators configured to control operation of the computer-controlled machine according to actuator control commands, and the client device is further configured to receive the private input content from the one or more sensors; and control the one or more actuators based on the actuator control command determined based on the final output

In one or more illustrative examples, a non-transitory computer-readable medium includes instructions of a mix algorithm that, when executed by one or more hardware processors of a client device, cause the client device to perform operations including to mix private input content with public input content to create a masked input, the mix obfuscating the private input content; send the masked input for processing by a server generative model to receive a server result; receive the server result from the server generative model; process the public input content using a local generative model to generate a local result; and combine the server result and the local result to remove a contribution of the public input content from the server result, thereby resulting in a final output to the private input content.

In one or more illustrative examples, the non-transitory computer-readable medium further includes instructions of the mix algorithm that, when executed by the one or more hardware processors of the client device, cause the client device to perform operations including to append the final output to the private input content and repeat the mix, send, receive, process, combine, and append until an end of output token is reached.

In one or more illustrative examples, the mix of the private input content with the public input content includes using a hyperparameter a that controls, at a word embedding level, how much weight is given to the private input content versus the public input content.

In one or more illustrative examples, the mix of the private input content with the public input content includes the addition and/or multiplication, to the output, of noise according to a probability distribution to preclude attempts to reverse the mixing.

In one or more illustrative examples, the noise is distributed according to a Gaussian distribution.

In one or more illustrative examples, the noise is distributed according to a uniform distribution.

In one or more illustrative examples, to combine includes to subtract the local result from the server result utilizing a hyperparameter 3 that adjusts an influence of the local result on the server result.

In one or more illustrative examples, to combine includes to perform an argmax operation to utilize token with highest logits.

In one or more illustrative examples, the non-transitory computer-readable medium further includes instructions of the mix algorithm that, when executed by the one or more hardware processors of the client device, cause the client device to perform operations including to perform the mix, send, receive, process, and combine a plurality of times with different public input content and the same private input content; and aggregate the results of the plurality of times to determine the final output, thereby increasing a possibility that tokens with largest logits after the aggregate are related the private input content.

In one or more illustrative examples, the client device is a robot including one or more sensors configured to measure aspects of a condition of a computer-controlled machine and one or more actuators configured to control operation of the computer-controlled machine according to actuator control commands, and the non-transitory computer-readable medium further includes instructions of the mix algorithm that, when executed by the one or more hardware processors of the client device, cause the client device to perform operations including to receive the private input content from the one or more sensors; and control the one or more actuators based on the actuator control command determined based on the final output.

### BRIEF DESCRIPTION OF THE DRAWINGS

FIG. 1 illustrates an example system for performing privacy-enhancing inference on pre-trained generative models;

FIG. 2 illustrates an example data flow of the input masking portion of the mix algorithm;

FIG. 3 illustrates an example data flow of the generative model processing portion of the mix algorithm;

FIG. 4 illustrates an example process for performing the mix algorithm;

FIG. 5 illustrates an example alternate data flow utilizing output aggregation;

FIG. 6 illustrates an example process for performing the mix algorithm with aggregation; and

FIG. 7 illustrates a schematic diagram of an interaction between a computer-controlled machine and a control system; and

FIG. 8 illustrates a schematic diagram of the control system configured to control a vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Generative models have achieved remarkable success across various domains, but their widespread adoption has raised significant privacy concerns. While existing research primarily focuses on protecting training data privacy and defending against user-initiated attacks, aspects of the disclosure relate to protecting user privacy when the server itself hosting the generative model is untrusted.

As discussed in detail herein, an approach for privacy-enhancing inference on pre-trained generative models is provided. The approach enables users to send masked queries to generative models and receive effective responses without directly exposing sensitive information in the queries. Key features of approach include masking of embeddings of the query (e.g., word embeddings for an LLM) that resist direct translation to tokens; retrieval of masked generative responses that do not contain pertinent information about the query; and client-side reconstruction of actual response from the masked response.

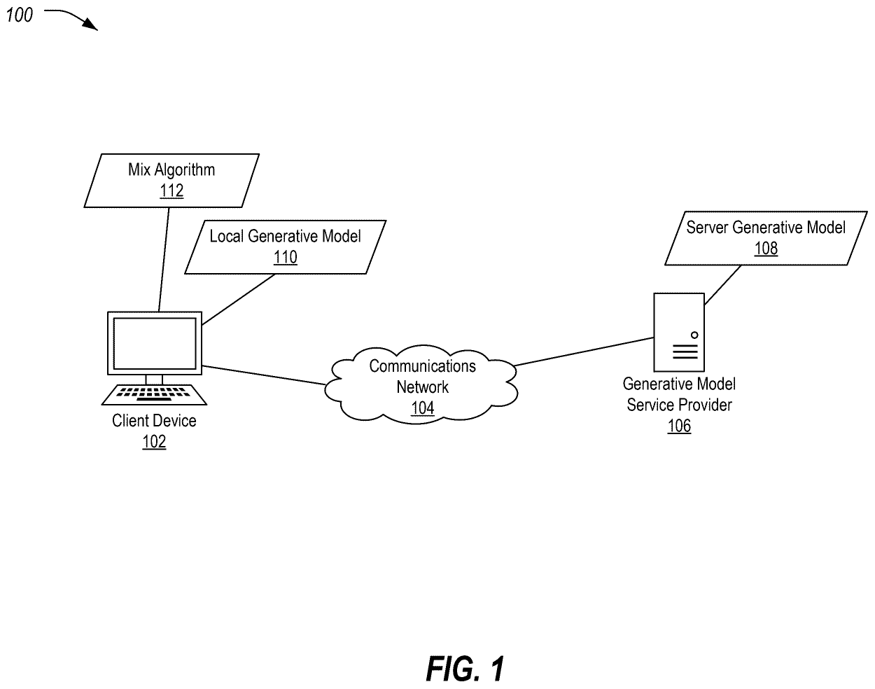

FIG. 1 illustrates an example system 100 for performing privacy-enhancing inference on pre-trained generative models. As shown, the system 100 includes a client device 102 in communication, over a communications network 104, with a generative model service provider 106. The server may execute a server generative model 108, while the client device 102 may execute a local generative model 110. The client device 102 may also execute a mix algorithm 112, as discussed in detail herein.

The client device 102 may refers to a hardware device that accesses services and resources provided by the generative model service provider 106 over the communications network 104. Common examples of client devices 102 include personal computers (PCs), laptops, smartphones, tablets, smartwatches, wearables, and gaming consoles. The client device 102 may be used to send requests to the LLM service provider 106, which process the requests and return the necessary data. The client devices 102 may include user interfaces that allow users to interact with software, send commands, and retrieve information.

The communications network 104 refers to infrastructure that enables the transmission and exchange of data between client devices 102 and the generative model service provider 106 across various locations. The communications network 104 may include various wired or wireless connections, such as fiber optics, Ethernet cables, cellular networks, Wi-Fi, and/or satellite networks. The communications network 104 may supports technologies and protocols to ensure efficient and reliable data transfer, including Transmission Control Protocol (TCP)/Internet Protocol (IP) for internet communications, hypertext transfer protocol (HTTP), secure hypertext transfer protocol (HTTPS), 4G/5G for mobile networks, controller area network (CAN) bus protocol, automotive Ethernet, Flexray, and/or Bluetooth for short-range device connections.

The generative model service provider 106 refers to a device or devices that provide services, data, or resources to the client device 102 or other computing devices over the communications network 104. The generative model service provider 106 may be configured to handle multiple requests simultaneously and may be equipped with robust hardware to ensure high availability, reliability, and performance. The generative model service provider 106 may be a physical machine or virtual instance hosted in the cloud, with cloud-based servers offering scalable and flexible resources that adjust based on demand.

The server generative model 108 may be a model designed to generate human-like text based on the input it receives. The server generative model 108 may be trained on extensive datasets, enabling the server generative model 108 to perform a wide variety of language-related tasks, such as answering questions, writing essays, generating code, summarizing documents, and even engaging in complex conversations. As GPT models scale in size, their capacity to understand nuanced language and handle more complex tasks improves. In many examples, the server generative model 108 may operate outside the control of the user of the client device 102. In some examples discussed herein, the server generative model 108 is a LLM such as a generative pretrained transformer (GPT) or another type of LLM such as llama, while in other cases the server generative model 108 may be another type of model such as a large multimodel model (LMM), an image model, etc.

More formally, GPT-based LLMs may be implemented as autoregressive models based on the transformer architecture, including self-attention mechanisms and feedforward neural networks. The inference process of GPT-based LLMs can be described as follows: For any text input, the text input first is converted into a sequence of tokens. Each token is then transformed into its corresponding word embedding, serving as the final input to the LLM. An input containing n tokens may be represented herein as x=x_{1:n}={x₁, x₂, . . . , xₙ}. During operation, the server LLM 108 generates the first token y₁ and appends it to the original input to form a new input. It continues to generate subsequent tokens. Under a greedy decoding setting, this process can be written as:

$${y}_{i} = softmax [ f ( {x}_{1 : n} + {y}_{1 : i - 1} ) ]$$

where:
yᵢ represents the i^{th} newly generated token in the generation process;
f(⋅) represents the LLM used, outputting logits;
x denotes the initial input token sequence;
y_{1:i-i} represents the tokens generated before yᵢ (an empty sequence when i=1); and
+ indicates the sequential merging of two sequences.
   This process repeats until a special token marking the end of generation is produced. Similar processing may be performed for LMMs or other types of model.

The local generative model 110 refers to a generative model that is comparable in function to the server generative model 108, but executed locally to the client device 102. As compared to the server generative model 108, the local generative model 110 may be a relatively smaller model requiring fewer computing resources to function. For example, as GPT models scale in size, their capacity to understand nuanced language and handle more complex tasks improves. Thus, the local generative model 110 may be relatively less capable than the server generative model 108. In some examples, the local generative model 110 may be scaled down version of the server generative model 108, while in other examples, the local generative model 110 may be a smaller model that is trained independent of the training of the server generative model 108.

The mix algorithm 112 refers to a software and/or hardware implemented approach for providing privacy-enhancing inference method for generative models. This method allows users to mask their queries to the generative model, receive answers in masked form, and then decode the actual generative model responses locally. Further details of the operation of the mix algorithm 112 are discussed in detail herein.

A user of the generative model service (hereafter referred to as the user) wishes to use a third-party server generative model 108, such as a chat model, and obtain effective responses without sharing any part of their specific input. It may be assumed that user can control the specific word embeddings input to the server generative model 108, x=[x₁, x₂, . . . , xₙ], and also access the logits f(x) produced by the server generative model 108. However, the user does not know the internal structure or other information about the server generative model 108.

It may be possible that an untrusted generative model service provider 106 aims to extract sensitive content from user inputs. In the context of the disclosure, untrusted refers to an honest-but-curious model, where the generative model service provider 106 may attempt to eavesdrop, analyze, and extract private information from the inputs and outputs sent to and from the server generative model 108. However, the generative model service provider 106 may not tamper with the inputs/outputs/computation inside server generative model 108.

It should be noted that examples of autonomous and semi-autonomous client devices 102 may include as intelligent appliances (intelligent dishwasher, oven, etc.), robotic appliances such as robotic lawnmowers, robotic vacuum cleaners, robots aimed at supporting humans in factory floors. In such cases, the local generative model 110 would run in the robot and the server generative model 108 may be hosted by an external generative model service provider 106 potentially in a remote geographic location. An aim is to make the LLM robot, appliance, etc. easy to use or interact with a human and to keep the queries private from the generative model service provider 106 that is considered external and potentially untrustworthy.

It may be assumed the generative model service provider 106 can directly view the user input received from the client device 102 and the generative model response from the server generative model 108. The generative model service provider 106 can convert word embeddings back to tokens, obtaining the specific content. Next, the generative model service provider 106 may attempt to identify potentially masked inputs and recover the original data using simple methods such as finding the nearest unmasked token in the word vector space (using similarity measures); however, this incurs some computation cost. Furthermore, the generative model service provider 106 might introduce additional instructions during the inference stage, such as requiring the generative model to first repeat the content of the question in the system prompt. Also, generative model service provider 106 can analyze the queries and responses transmitted by a particular user and apply techniques such as back translation for comprehensive analysis of these requests.

To address these concerns, the mix algorithm 112 is configured to mask questions, send masked questions to the generative model service provider 106, and receive similarly masked answers. Since the specific server generative model 108 being used is unknown, this data flow 200 may be directly applicable to pre-trained generative models without requiring special training or fine-tuning.

Almost all LLMs are trained on human language texts and are used to generate human language. Therefore, traditional masking methods that significantly shift the input distribution, such as asymmetric masking, may reduce the effectiveness or even prevent the server generative model 108 from producing meaningful responses to masked inputs. Thus, the mix algorithm 112 may utilize a masking approach that alters the input distribution as little as possible while allowing the server generative model 108 to produce meaningful responses to masked inputs.

To hide plaintext information in the input while maintaining the input distribution, a mix-up approach may be used to combine multiple inputs. Formally, a mix-up approach for use in the generative model context may include an attempt to mix up two inputs at the word embedding level. For two input sequences x₁, x₂ with the same number of tokens, the sequences are assigned weights α, (1−α) respectively, and then are added directly. That is:

$${x}_{mix} = α \cdot {x}_{1} + ( 1 - α ) \cdot {x}_{2}$$

It may be observed that, as the mixing weight a changes, the output tokens and the semantics of the generated content gradually change. This indicates that the mix-up method should remain effective at the inference stage. Thus, the hyperparameter a may be a private value that controls, at a word embedding level, how much weight is given to the private input content versus the public input content.

Furthermore, it may be observed that when the weight coefficients differ significantly, for instance, when α is greater than or equal to 2(1−α), the input x₁ with the larger weight tends to dominate the output. This means that in the output distribution, the generative model assigns high confidence to tokens related to x₁, resulting in output that approximates the case where only x₁ is used as input.

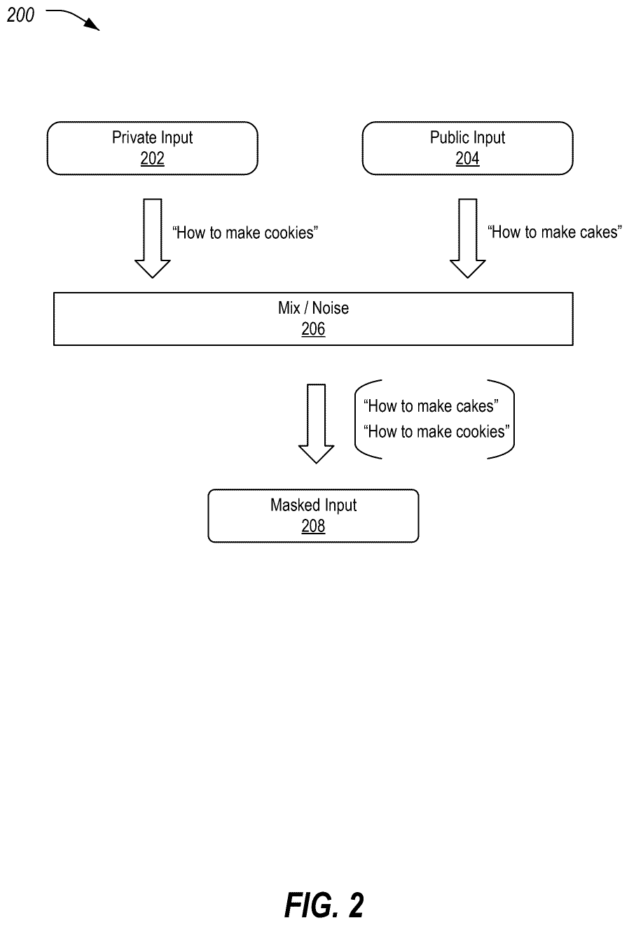

FIG. 2 illustrates an example data flow 200 of the input masking portion of the mix algorithm 112. Using the input masking, the input content is masked so that it is not displayed in plaintext while allowing the server generative model 108 to generate effective feedback.

Private input content 202 may refer to the user query to be answered by the server generative model 108. The private input content 202 may also be referred to herein as xₚᵣᵥ. To conceal the plaintext information in xₚᵣᵥ, the private input content 202 may be masked by mixing private input content 202 with public text content 204, denoted as x_{pub}. This public text content 204 may be sourced either from a large corpus of text available on the internet or generated by a generative model itself (such as using the local generative model 110). As shown, the private input content 202 and the public text content 204 may be provided to a mix/noise operation 206 of the mix algorithm 112, which may produce a masked input 208. That is:

$${x}_{m i x} = α \cdot {x}_{p r v} + ( 1 - α ) \cdot {x}_{p u b} + N ( μ , {σ}^{2} )$$

where:
xₘᵢₓ represents the masked input 208, and
N(μ, σ²) represents a noise distribution, in this example Gaussian noise with mean μ and standard deviation σ.

Since each token vector in xₘᵢₓ is a superposition of two or more tokens, its magnitude and direction differ significantly from the corresponding token in xₚᵣᵥ. Since the mixed token vectors do not directly exist in the tokenizer's dictionary, the mixed input cannot be directly translated into text. On the other hand, given that the number of tokens is finite (on the order of 30,000 tokens, but could be more or fewer) in the vast majority of current generative models, an attacker might potentially infer the tokens in xₚᵣᵥ by exhaustively computing weighted sums of all possible token pairs. While this approach would incur an extremely high computational cost, it is not impossible. The introduction of a noise distribution effectively precludes such attack attempts. Thus, adding slight noise using the mix/noise operation 206 makes the magnitude and direction difference even stronger and harder to reverse. As shown in many examples herein, the noise distribution is corresponding to a Gaussian, but this is only one possibility and other distributions of randomness may be used such as a uniform distribution. Also, as shown in many examples, the noise is additive noise, but in other examples this could be multiplicative noise.

It should be noted that the values of α and (1−α) should be comparable. Empirically, their difference should not exceed a factor of two. This is due to the domination effect mentioned above. Specifically, when α and (1−α) differ significantly, the server generative model 108 may directly address the question with the larger weight, potentially increasing the risk of privacy leakage. The generative model service provider 106 may employ back-translation methods to retrieve the question, i.e., re-inputting the response that was generated by the server generative model 108 and asking the server generative model 108 to guess the corresponding question. Alternatively, the generative model service provider 106 may simply instruct the server generative model 108 to reiterate the question before generating a response.

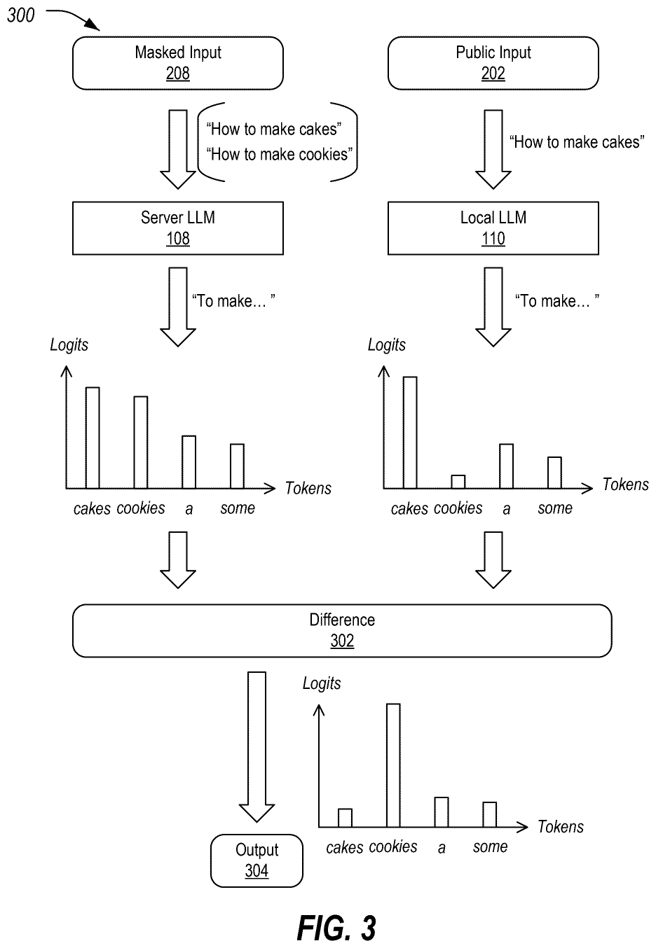

FIG. 3 illustrates an example data flow 300 of the generative model processing portion of the mix algorithm 112. As shown, the masked input 208 may be provided to the generative model service provider 106 for processing by the server generative model 108. The server output may be provided as follows:

$${l}_{m i x} = {f}_{s e r v e r} ( {x}_{m i x} )$$

where:
fₛₑᵣᵥₑᵣ(⋅) represents the server generative model 108 provided by the generative model service provider 106, and
lₘᵢₓ represents the logits of the first token generated by the server generative model 108.

Based on experimental observations, tokens related to both xₚᵣᵥ and x_{pub} may have relatively large values in lₘᵢₓ, meaning the server generative model 108 is likely to generate content related to either xₚᵣᵥ or x_{pub}. Since the goal is to obtain the response from the server generative model 108 to the private input content 202, xₚᵣᵥ, the probability of tokens related to x_{pub} in lₘᵢₓ should be reduced. To accomplish this, the local generative model 110 may be used to generate a response l_{pub} to x_{pub}. Then a difference operation 302 may be performed to remove l_{pub} from lₘᵢₓ:

$$\begin{matrix}{l}_{p u b} = {f}_{local} ( {x}_{p u b} ) \\ {l}_{f i n a l} = {l}_{m i x} - β \cdot {l}_{p u b}\end{matrix}$$

Since the local generative model 110, f_{local}, is used to obtain l_{pub}, this approach can be completed on the user side, e.g., on the client device 102, reducing risk of private information leakage. Using this approach, a final output 304, referred to as l_{final}, may be obtained. In the final output 304, tokens related to the private input content 202 (xₚᵣᵥ) have larger values, meaning the server generative model 108 is more likely to generate content related to the private input content 202 (xₚᵣᵥ). The hyperparameter R may thus be a private value that adjusts the influence of the local result on the server result.

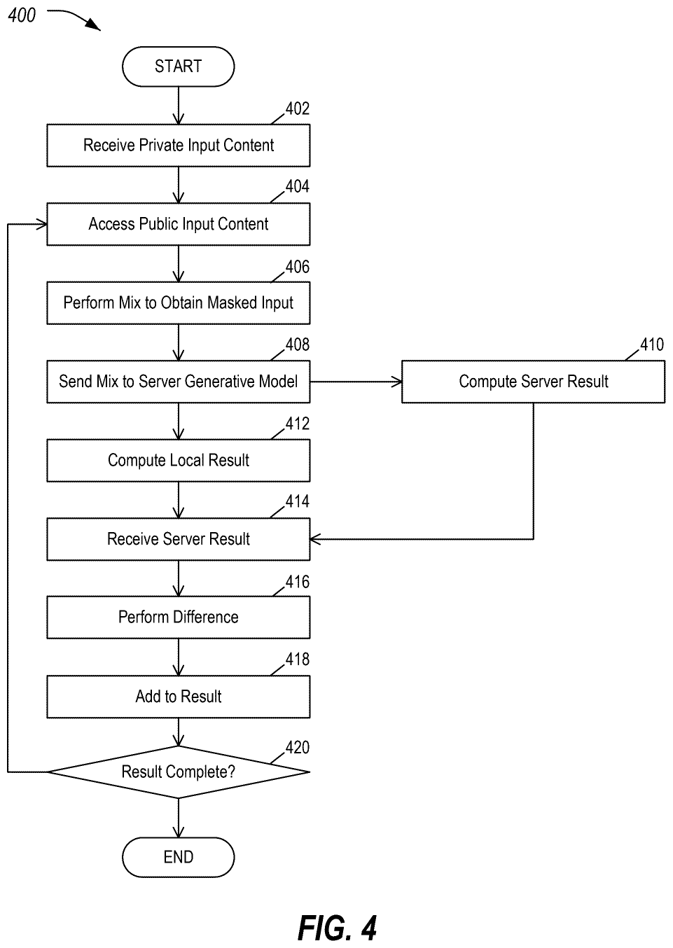

FIG. 4 illustrates an example process 400 for performing the mix algorithm 112. In an example, the process 400 may be performed using the system 100 as discussed in detail with respect to FIGS. 1-3.

At operation 402, the client device 102 receives the private input content 202 from a user. In an example, the user may enter a prompt or query into a user interface of the client device 102. The input may be received using a variety of input methods, which may include one or more of vision, sound, typing, actuation, etc.

At operation 404, the client device 102 accesses the public text content 204. In an example, the client device 102 may store or otherwise have access to public text content 204 that includes information that may be queried to the server generative model 108.

At operation 406, the client device 102 performs the mix/noise operation 206 of the mix algorithm 112. In an example, the mix/noise operation 206 masks the private input xₚᵣᵥ with the public input x_{pub} locally, obtaining the masked input 208 xₘᵢₓ. In an example, the mix/noise operation 206 is performed at the word embedding level.

At operation 408, the client device 102 sends xₘᵢₓ to the generative model service provider 106 for processing by the server generative model 108, fₛₑᵣᵥₑᵣ. In an example, the masked input 208 is sent from the client device 102 over the communications network 104 to the generative model service provider 106 to be provided to the server generative model 108.

At operation 410, responsive to receiving xₘᵢₓ, the server generative model 108 computes the logits lₘᵢₓ for the predicted next token and returns them to the client device 102.

At operation 412, which may be performed simultaneously to operation 410, the client device 102 uses the local generative model 110, f_{local}, to compute and obtain the logits l_{pub} for the next token of the public input x_{pub}.

At operation 414, the logits lₘᵢₓ are received from generative model service provider 106 as computed by the server generative model 108.

At operation 416, the client device 102 performs the difference operation 302 to calculate the difference between lₘᵢₓ and l_{pub}, to obtain the final de-masked output distribution l_{final}. By selecting the tokens with the largest logits in l_{pub} and l_{final}, the client device 102 obtains the next tokens for x_{pub} and xₚᵣᵥ respectively.

At operation 418, the resultant tokens are appended to the final output 304. For instance, the current x_{pub} and xₚᵣᵥ are appended to form new x_{pub} and xₚᵣᵥ. The final output 304 of the protocol is the set of tokens the user obtains from the server generative model 108 with xₚᵣᵥ as the initial input.

At operation 420, the client device 102 repeats the above steps with new x_{pub} and xₚᵣᵥ until output is complete. Complete output may be determined, for example, by identification of a specific token indicating the end of output. If the end of output is indicated, the process 400 ends. Otherwise, the process 400 returns to operation 404.

Formally, the process 400 may be described as follows by Algorithm 1:

Algorithm 1: Mix

Input: Local generative model f_{local}; Server-side generative model fₛₑᵣᵥₑᵣ;
Private input xₚᵣᵥ; Public input x_{pub}; Hyperparameters: α, β; Parameters of
Gaussian noise μ, σ;

| | |
|---|---|
| 1: | while True do |
| 2: | xₘᵢₓ = α · xₚᵣᵥ + (1 − α) · x_{pub} + N(μ, σ²) |
| 3: | lₘᵢₓ = fₛₑᵣᵥₑᵣ(xₘᵢₓ) |
| 4: | l_{pub} = f_{local}(x_{pub}) |
| 5: | l_{final} = lₘᵢₓ − β · l_{pub} |
| 6: | xₚᵣᵥ ← xₚᵣᵥ ⊕ argmax(l_{final}) |
| 7: | x_{pub} ← x_{pub} ⊕ argmax(l_{pub}) |
| 8: | if fₛₑᵣᵥₑᵣ end output then |
| 9: | break |
| 10: | end |
| 11: | end |

It should be noted that the argmax operation refers to an operation to utilize the token with the highest logits, and ⊕ refers to an operation to splice two strings together in order.

In some cases, the l_{final} computed in the Mix & Decode step may not be relevant to the private input xₚᵣᵥ. For example, when facing complex tasks, a powerful server-side generative model might produce outputs with high confidence, while the weaker generative model used in the local decoding phase might produce outputs with uniformly low confidence. This could result in the maximum value in l_{final} failing to correctly answer the private input xₚᵣᵥ.

To address this issue, an alternate approach may be performed using multiple different public text queries x_{pub} to mix up with xₚᵣᵥ separately, followed by an aggregation of the results of the multiple mixtures.

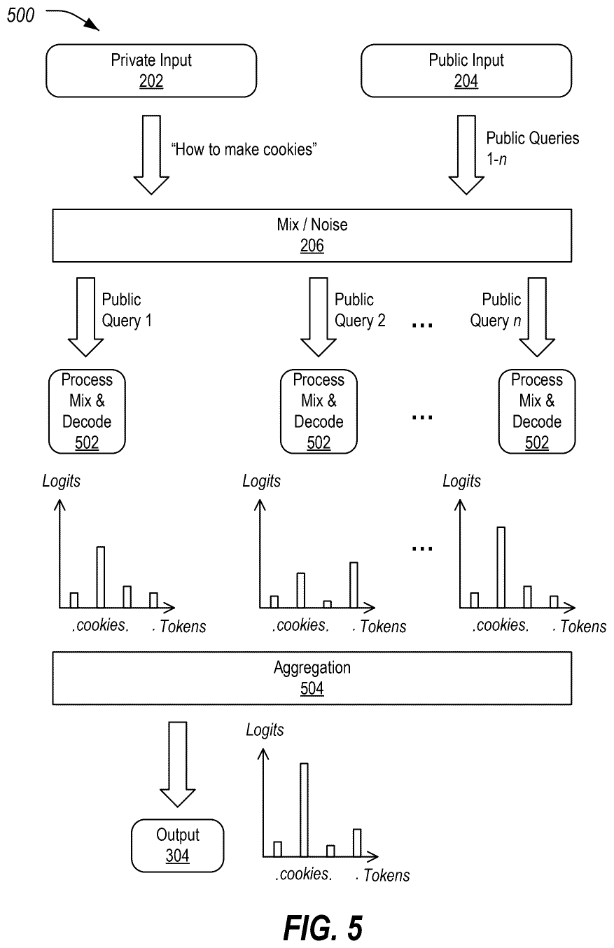

FIG. 5 illustrates an example alternate data flow 500 utilizing output aggregation. As shown, private input contents 202 are processed by the mix/noise operation 206, which perform a plurality of mixings of the private input content 202 to generate a set of masked inputs 208. These may be represented mathematically as public queries q_{pub}¹ through q_{pub}ⁿ. Each of the masked inputs 208 may then be processed in a mix/decode operation 502 by the server generative model 108 and the local generative model 110 as discussed herein, such that for each of masked inputs 208, the difference operation 302 is performed to produce intermediate outputs for each public query. These intermediate outputs are then processed by an aggregation 504 to produce the final output 304.

This approach may be defined mathematically as follows:

$$\begin{matrix}{l}_{final} = \frac{1}{n} {\sum }_{i}^{n} {f}_{server} ( α \cdot {x}_{p r v} + ( 1 - α ) \cdot {x}_{p u b}^{i} + N ( μ , {σ}^{2} ) ) - β \cdot {f}_{local} ( {x}_{pub} ) , \\ where i ∈ \{ 1 , 2 , … , n \}\end{matrix}$$

The illustrated aggregation 504 approach may include various benefits. For example, and as mentioned earlier, l_{final} may produce poor results in isolated cases. Using multiple different x_{pub} and aggregating can dilute such cases. Note that x_{pub} is independent of xₚᵣᵥ and can be of any type. It can be any sentence that prompts the generative model to generate a response. This means that x_{pub} can be easily obtained at random at low cost, which increases the difficulty for the attack to find x_{pub}.

As another benefit, since xₚᵣᵥ remains constant while

$${x}_{p u b}^{i}$$

varies across multiple mix-up inputs, tokens related to xₚᵣᵥ will consistently have larger logits values in each sampled l_{final}. This increases the probability that the token with the largest logits after the aggregation 504 is related to xₚᵣᵥ.

Based on these operations, the first token of the result text may be generated without revealing the plaintext information in the user query. Subsequently, the generated token may be appended to the original xₚᵣᵥ as the private input xₚᵣᵥ for the next round. As this would increase the length of xₚᵣᵥ, the local model f_{local}(⋅) may be used to generate the next token of x_{pub} to align with xₚᵣᵥ, and also compute the next round's xₘᵢₓ, and repeat this process until the response is complete.

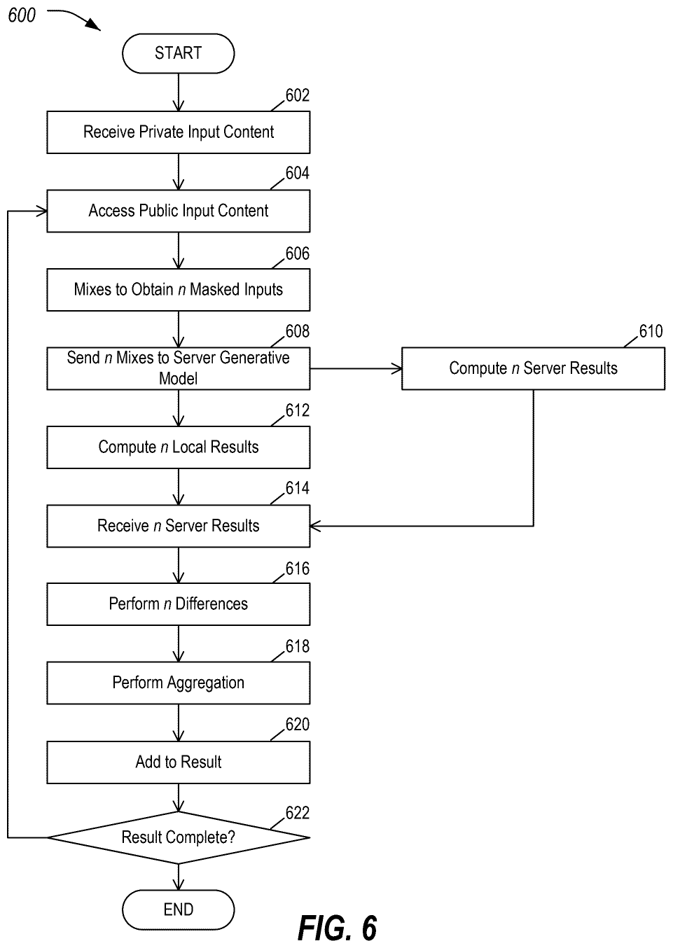

FIG. 6 illustrates an example process 600 for performing the mix algorithm 112 with aggregation 504. Similar to the process 400, the process 600 may be performed using the system 100 as discussed in detail with respect to FIGS. 1-5.

At operation 602, similar to operation 402 the client device 102 receives the private input content 202 from a user.

At operation 604, similar to operation 404 the client device 102 accesses the public text content 204. However, instead of a single retrieval, multiple different aspects of the public text content 204 may be accessed to create a plurality of masked inputs 208.

At operation 606, similar to operation 606 the client device 102 performs the mix/noise operation 206 of the mix algorithm 112. However, in this example, the client device 102 creates the plurality of masked inputs 208 instead of a single masked input 208.

At operation 608, similar to operation 408 the client device 102 sends the plurality of masked inputs 208 xₘᵢₓ (e.g.,

$${x}_{m i x}^{i}$$

where i={1 . . . n}) to the generative model service provider 106 for processing by the server generative model 108, fₛₑᵣᵥₑᵣ.

At operation 610, similar to operation 410 responsive to receiving each of the

$${x}_{mix}^{i} ,$$

the server generative model 108 computes respective logits

$${l}_{m i x}^{i}$$

for the predicted next token and returns them to the client device 102.

At operation 612, similar to operation 610 the client device 102 uses the local generative model 110, f_{local}, to compute and obtain the logits

$${l}_{p u b}^{i}$$

for the next token of the public input

$${x}_{p u b}^{i} .$$

At operation 614, similar to operation 414 the logits

$${l}_{m i x}^{i}$$

are received from generative model service provider 106 as computed by the server generative model 108.

At operation 616, similar to operation 416 the client device 102 performs the difference operation 302 for each

$${l}_{m i x}^{i}$$

to calculate the difference between

$${l}_{mix}^{i} and {l}_{p u b}^{i} ,$$

to obtain the final de-masked output distribution

$${l}_{final}^{i} .$$

At operation 618, the aggregation 504 is performed on the set of

$${l}_{final}^{i}$$

to add to the final output 304.

At operation 620, similar to operation 418 the resultant tokens are appended to the final output 304. For instance, the current x_{pub} and xₚᵣᵥ are appended to form new x_{pub} and xₚᵣᵥ. The final output 304 of the protocol is the set of tokens the user obtains from the server generative model 108 with xₚᵣᵥ as the initial input.

At operation 622, similar to operation 420 the client device 102 repeats the above steps with new x_{pub} and xₚᵣᵥ until output is complete. Complete output may be determined, for example, by identification of a specific token indicating the end of output. If the end of output is indicated, the process 600 ends. Otherwise, the process 600 returns to operation 604.

Formally, the process 600 including aggregation 504 may be described as follows by Algorithm 2:

Algorithm 2: Mix with Aggregation

Input: Local generative model f_{local}; Server-side generative model fₛₑᵣᵥₑᵣ; Private input xₚᵣᵥ;
$Public inputs \{ {x}_{pub}^{1} , {x}_{p u b}^{2} , … , {x}_{p u b}^{n} \} ; Hyperparameters α , β ; Parameters of Gaussian noise μ , σ .$

| | |
|---|---|
| 1: | while True do |
| 2: | $for every {x}_{p u b}^{i} in \{ {x}_{pub}^{1} , {x}_{pub}^{2} , … , {x}_{p u b}^{n} \} do$ |
| 3: | ${x}_{m i x}^{i} = α \cdot {x}_{p r v} + ( 1 - α ) \cdot {x}_{p u b}^{i} + 𝒩 ( μ , {σ}^{2} )$ |
| 4: | ${l}_{m i x}^{i} = {f}_{s e r v e r} ( {x}_{m i x}^{i} )$ |
| 5: | ${l}_{p u b}^{i} = {f}_{local} ( {x}_{p u b}^{i} )$ |
| 6: | ${l}_{final}^{i} = {l}_{m i x}^{i} - β \cdot {l}_{p u b}^{i}$ |
| 7: | end |
| 8: | ${l}_{final} = \frac{1}{n} \sum {l}_{final}^{i}$ |
| 9: | xₚᵣᵥ ← xₚᵣᵥ ⊕ arg max (l_{final}) |
| 10 | $for every {x}_{p u b}^{i} in \{ {x}_{p u b}^{1} , {x}_{p u b}^{2} , … , {x}_{p u b}^{n} \} do$ |
| 11: | ${x}_{p u b}^{i} ← {x}_{p u b}^{i} ⊕ arg max ( {l}_{p u b}^{i} )$ |
| 12: | end |
| 13: | if fₛₑᵣᵥₑᵣ end output then |
| 14: | break |
| 15: | end |
| 16: | end |

The following are examples of the operation of the system 100 to better explain its operation:

Example1:

Input: Vicuna-7b for the local LLM 110, Vicuna-13b for the server LLM 108;
with hyperparameters: α = 0.5, β = 0.7, μ = 0, σ = 0.01
Private input content 202 query: “is elder scrolls online the same as skyrim”
Public text content 204 query: “is the federal court the same as the supreme court “
Masked input 208 query (nearest tokens): are elder res stra it islands part sk austral im
Response seen by the client device 102 using mix algorithm 112: Greetings, human gamer!
Elder Scrolls Online (ESO) and Skyrim are both part of the Elder Scrolls franchise, but they are
not the the same thing.<0x0A>. Skyrim is a single-player offline RPG game, while ESO is a
massively multiplayer online role-playing game (MMORPG).<0x0A>Skrim is set in the titular
province of Skyrim, wihch is part of the Tamriel
Response seen by the generative model service provider 106 hosting the server generative model
108: No,! As a Iful to, the Ass of.′s′s I's the answer to. ′s of ′s′s‘ f00

Example2:

Input: Llama2-7b-chat for the local LLM 110, and Llama2-13b-chat for the server LLM 108;
with hyperparameters: α = 0.5, β = 0.7, μ = 0, σ = 0.01
Private input content 202 query: is there sales tax in the state of washington
Public text content 204 query: are tomato puree and tomato paste the same
Masked input 208 query (nearest tokens): are tom sales puree and tomato pastehing same’
Response seen by the client device 102 using mix algorithm 112: Good day! There are no sales
taxes in Washington state, as it is one of the states that does not have a state sales tax.
Washington state does, however, impose other taxes, such as the state sales tax, property tax,
and other local taxes. specific locations within the state may have their own tax rates and
regulations, it's always best to check with the local government or tax authority for the most up-
to-date and accurate information on tax
Response seen by the generative model service provider 106 hosting the server generative model
108: Thank you for reaching out! I'm here to help you with your question. Tomato puree and
tomato paste are actually not the same thing, although they are related. Tomato puree is a
smooth, blended sauce made from cooked and pureed tomatoes, while tomato paste is a
concentrated, thick paste made from cooked and blended tomatoes. Tomato puree is often used
in recipes as a base for soups, sauces, and stews, while tomato paste is commonly used as a
seasoning or condiment to add depth of flavor to dishes. Tomato puree has a more watery
consistency than tomato paste, which is thicker and more concentrated

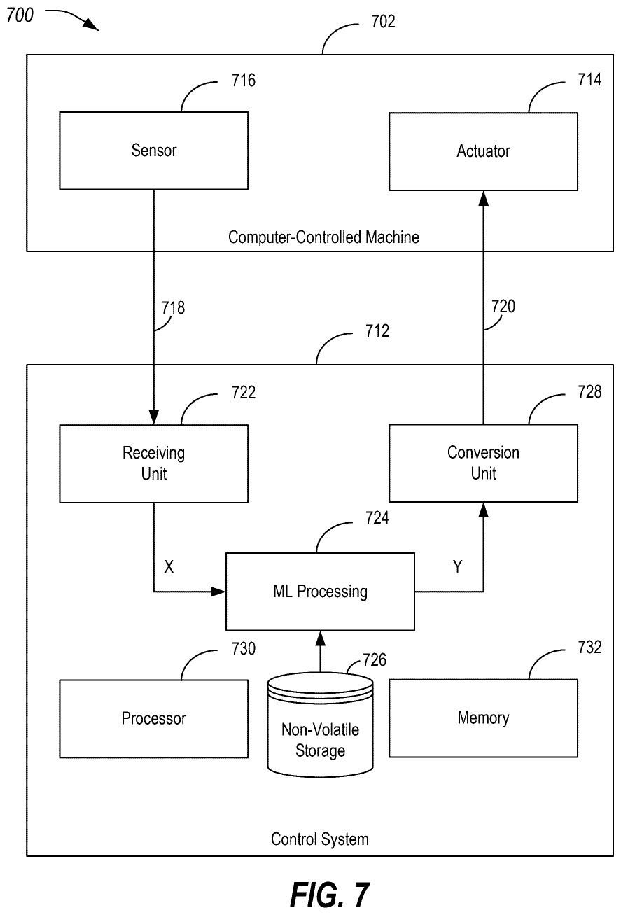

FIG. 7 depicts a schematic diagram of an interaction between a computer-controlled machine 702 and a control system 712. The computer-controlled machine 702 may implement aspects of the privacy-enhancing generation on pre-trained generative models, e.g., as a client device 102 in communication over the communications network 104 with the generative model service provider 106. Referring to FIG. 7, and with reference to FIGS. 1-6, the approaches discussed herein may be performed in the context of such a computer-controlled machine 702 and control system 712. The computer-controlled machine 702 includes actuator 714 and sensor 716. Actuator 714 may include one or more actuators and sensor 716 may include one or more sensors. Sensor 716 is configured to sense a condition of computer-controlled machine 702. Sensor 716 may be configured to encode the sensed condition into sensor signals 718 and to transmit sensor signals 718 to control system 712. Non-limiting examples of sensor 716 include video, radar, LiDAR, ultrasonic, motion, sound, power consumption and electromagnetic (EM) radiation sensors. In one embodiment, sensor 716 is an optical sensor configured to sense optical images of an environment proximate to computer-controlled machine 702.

Control system 712 is configured to receive sensor signals 718 from computer-controlled machine 702. As set forth below, control system 712 may be further configured to compute actuator control commands 720 depending on the sensor signals 718 and to transmit actuator control commands 720 to actuator 714 of computer-controlled machine 702.

As shown in FIG. 7, control system 712 includes receiving unit 722. Receiving unit 722 may be configured to receive sensor signals 718 from sensor 716 and to transform sensor signals 718 into input signals X. In an alternative embodiment, sensor signals 718 are received directly as input signals X without receiving unit 722. Each input signal x may be a portion of each sensor signal 718. Receiving unit 722 may be configured to process each sensor signal 718 to product each input signal x. Input signal x may include data corresponding to an image recorded by sensor 716.

Control system 712 includes machine learning (ML) processing 724. ML processing 724 may be configured to learn, classify, infer, generate, etc. using one or more models such as those described in detail above. In an example, ML processing 724 is configured to determine output signals Y from input signals X. Each output signal y includes information that assigns one or more labels to each input signal X. ML processing 724 may transmit output signals Y to conversion unit 728. Conversion unit 728 is configured to convert output signals Y into actuator control commands 720. Control system 712 is configured to transmit actuator control commands 720 to actuator 714, which is configured to actuate computer-controlled machine 702 in response to actuator control commands 720. In another embodiment, actuator 714 is configured to actuate computer-controlled machine 702 based directly on output signals Y.

Upon receipt of actuator control commands 720 by actuator 714, actuator 714 is configured to execute an action corresponding to the related actuator control command 720. Actuator 714 may include a control logic configured to transform actuator control commands 720 into a second actuator control command 720, which is utilized to control actuator 714. In one or more embodiments, actuator control commands 720 may be utilized to control a display instead of or in addition to an actuator 714.

In another embodiment, control system 712 includes sensor 716 instead of or in addition to computer-controlled machine 702 including sensor 716. Control system 712 may also include actuator 714 instead of or in addition to computer-controlled machine 702 including actuator 714.

As shown in FIG. 7, control system 712 also includes processor 730 and memory 732. Processor 730 may include one or more processors. Memory 732 may include one or more memory devices. The causal hyper-relation links determined by one or more embodiments may be implemented by control system 712, which includes non-volatile storage 726, processor 730 and memory 732.

Non-volatile storage 726 may include one or more persistent data storage devices such as a hard drive, optical drive, tape drive, non-volatile solid-state device, cloud storage or any other device capable of persistently storing information. Processor 730 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 732. Memory 732 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 730 may be configured to read into memory 732 and execute computer-executable instructions residing in non-volatile storage 726 and embodying one or more ML algorithms and/or methodologies of one or more embodiments. Non-volatile storage 726 may include one or more operating systems and applications. Non-volatile storage 726 may store compiled and/or interpreted from computer programs created using a variety of programming languages and/or technologies, including, without limitation, and either alone or in combination, Java, C, C++, C#, Objective C, Fortran, Pascal, JavaScript, Python, and Perl.

Upon execution by processor 730, the computer-executable instructions of non-volatile storage 726 may cause control system 712 to implement one or more of the ML algorithms and/or methodologies as disclosed herein (such as those of the local generative model 110 and the mix algorithm 112). Non-volatile storage 726 may also include ML data (including data parameters) supporting the functions, features, and processes of the one or more embodiments described herein.

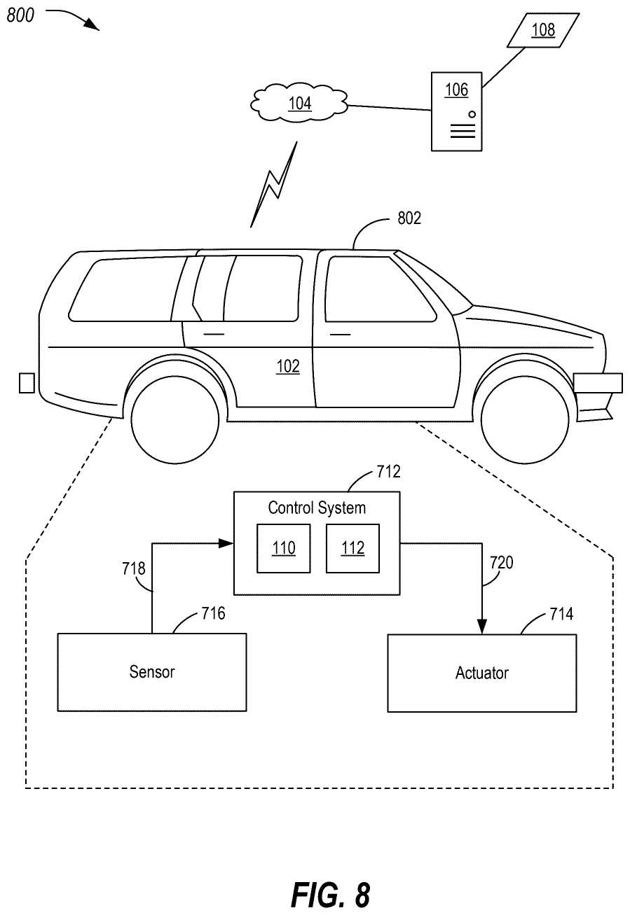

FIG. 8 illustrates a schematic diagram 800 of the control system 712 configured to control a vehicle 802, which may be an at least partially autonomous vehicle or an at least partially autonomous robot. The vehicle 802 may operate as the client device 102 in communication over the communications network 104 with the generative model service provider 106 hosting the server generative model 108, while the control system 712 of the vehicle 802 may execute the local generative model 110 and the mix algorithm 112, as discussed in detail herein.

As shown in FIG. 8, the vehicle 802 includes an actuator 714 and a sensor 716. The sensor 716 may include one or more video sensors, radar sensors, ultrasonic sensors, LiDAR sensors, and/or position sensors (e.g., global navigation satellite system (GNSS)). One or more of the one or more specific sensors may be integrated into the vehicle 802. Alternatively, or in addition to one or more specific sensors identified above, the sensors 716 may include a software module configured to, upon execution, determine a state of the actuator 714. One non-limiting example of a software module includes a weather information software module configured to determine a present or future state of the weather proximate vehicle 802 or other location.

The ML processing 724 of the control system 712 of the vehicle 802 may be configured to detect objects in the vicinity of the vehicle 802 dependent on input signals X. In such an embodiment, output signal Y may include information characterizing the vicinity of objects to the vehicle 802. An actuator control command 720 may be determined in accordance with this information. The actuator control command 720 may be used to avoid collisions with the detected objects.

In embodiments where the vehicle 802 is an at least partially autonomous vehicle, the actuator 714 may be embodied in a brake, a propulsion system, an engine, a drivetrain, or a steering of the vehicle 802. The actuator control commands 720 may be determined such that the actuator 714 is controlled such that the vehicle 802 avoids collisions with detected objects.

Detected objects may be classified according to a query processed by the vehicle 802 operating as the client device 102 using the mix algorithm 112. For instance, in a LMM example, the vehicle 802 may provide data from the sensor 716 and a textual prompt for processing to classify and/or otherwise understand the contents of the captured data. This may be provided as the private input 202, which is then mixed with public input 204 and provided over the communications network 104 for processing by the generative model service provider 106 as discussed herein. The result may be determined using the results from the server generative model 108 and the local generative model 110 as discussed in detail herein. The actuator control commands 720 may be determined depending on the classification.

In other embodiments where the vehicle 802 is an at least partially autonomous robot, the vehicle 802 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 720 may be determined such that a propulsion unit, steering unit and/or brake unit of the mobile robot may be controlled such that the mobile robot may avoid collisions with identified objects.

In another embodiment, the vehicle 802 is an at least partially autonomous robot in the form of a gardening robot. In such embodiment, the vehicle 802 may use an optical sensor as sensor 716 to determine a state of plants in an environment proximate the vehicle 802. The actuator 714 may be a nozzle configured to spray chemicals. Depending on an identified species and/or an identified state of the plants as identified using the data from the sensor 716 and the mix algorithm 112, the actuator control command 720 may be determined to cause the actuator 714 to spray the plants with a suitable quantity of suitable chemicals.

In yet another example, the client device 102 may be an at least partially autonomous robot in the form of a domestic appliance. Non-limiting examples of domestic appliances include a washing machine, a stove, an oven, a microwave, or a dishwasher. In such a vehicle 802, the sensor 916 may be an optical sensor configured to detect a state of an object which is to undergo processing by the household appliance.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as ASICs, FPGAs, state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for privacy-enhancing interaction with generative models, comprising:
mixing private input content with public input content to create a masked input, the mixing obfuscating the private input content;
sending the masked input for processing by a server generative model to receive a server result;
receiving the server result from the server generative model;
processing the public input content using a local generative model to generate a local result; and
combining the server result and the local result to remove a contribution of the public input content from the server result, thereby resulting in a final output to the private input content.

2. The method of claim 1, further comprising appending the final output to the private input content and repeating the mixing, sending, receiving, processing, combining, and appending until an end of output token is reached.

3. The method of claim 1, wherein the mixing of the private input content with the public input content includes using a hyperparameter a that controls, at a word embedding level, how much weight is given to the private input content versus the public input content.

4. The method of claim 3, wherein the mixing of the private input content with the public input content includes the addition and/or multiplication, to the output, of noise according to a probability distribution to preclude attempts to reverse the mixing.

5. The method of claim 4, wherein the noise is distributed according to a Gaussian distribution.

6. The method of claim 4, wherein the noise is distributed according to a uniform distribution.

7. The method of claim 1, wherein the server generative model is a model having greater computational ability and greater resource requirements as compared to the local generative model.

8. The method of claim 1, wherein the combining includes subtracting the local result from the server result utilizing a hyperparameter 3 that adjusts an influence of the local result on the server result.

9. The method of claim 1, wherein the combining includes performing an argmax operation to utilize token with highest logits.

10. The method of claim 1, further comprising:
performing the mixing, sending, receiving, processing, and combining a plurality of times with different public input content and the same private input content; and
aggregating the results of the plurality of times to determine the final output, thereby increasing a possibility that tokens with largest logits after the aggregating are related the private input content.

11. The method of claim 1, wherein the client device is a robot including one or more sensors configured to measure aspects of a condition of a computer-controlled machine and one or more actuators configured to control operation of the computer-controlled machine according to actuator control commands, and further comprising:
receiving the private input content from the one or more sensors; and
controlling the one or more actuators based on the actuator control command determined based on the final output.

12. A system for privacy-enhancing inferencing with generative models, comprising:
a client device comprising one or more hardware processors and one or more memories storing a local generative model and a mix algorithm, the client device being configured to execute instructions of the mix algorithm to perform operations including to:
mix private input content with public input content to create a masked input, the mix obfuscating the private input content;
send the masked input for processing by a server generative model to receive a server result;
receive the server result from the server generative model;
process the public input content using the local generative model to generate a local result; and
combine the server result and the local result to remove a contribution of the public input content from the server result, thereby resulting in a final output to the private input content.

13. The system of claim 12, wherein the client device is further configured to execute the instructions of the mix algorithm to perform operations including to append the final output to the private input content and repeat the mix, send, receive, process, combine, and append until an end of output token is reached.

14. The system of claim 12, wherein the mix of the private input content with the public input content includes using a hyperparameter a that controls, at a word embedding level, how much weight is given to the private input content versus the public input content.

15. The system of claim 14, wherein the mix of the private input content with the public input content includes the addition and/or multiplication, to the output, of noise according to a probability distribution to preclude attempts to reverse the mixing.

16. The system of claim 15, wherein the noise is distributed according to a Gaussian distribution.

17. The system of claim 15, wherein the noise is distributed according to a uniform distribution.

18. The system of claim 12, wherein the server generative model is a model having greater computational ability and greater resource requirements as compared to the local generative model.

19. The system of claim 12, wherein to combine includes to subtract the local result from the server result utilizing a hyperparameter R that adjusts an influence of the local result on the server result.

20. The system of claim 12, wherein to combine includes to perform an argmax operation to utilize token with highest logits.

21. The system of claim 12, wherein the client device is further configured to execute the instructions of the mix algorithm to perform operations including to:
perform the mix, send, receive, process, and combine a plurality of times with different public input content and the same private input content; and
aggregate the results of the plurality of times to determine the final output, thereby increasing a possibility that tokens with largest logits after the aggregate are related the private input content.

22. The system of claim 12, further comprising a generative model service provider comprising one or more hardware processors and one or more memories storing the server generative model in communication over a communications network with the client device.

23. The system of claim 12, wherein the client device is a robot including one or more sensors configured to measure aspects of a condition of a computer-controlled machine and one or more actuators configured to control operation of the computer-controlled machine according to actuator control commands, and the client device is further configured to:
receive the private input content from the one or more sensors; and
control the one or more actuators based on the actuator control command determined based on the final output.

24. A non-transitory computer-readable medium comprising instructions of a mix algorithm that, when executed by one or more hardware processors of a client device, cause the client device to perform operations including to:
mix private input content with public input content to create a masked input, the mix obfuscating the private input content;
send the masked input for processing by a server generative model to receive a server result;
receive the server result from the server generative model;
process the public input content using a local generative model to generate a local result; and
combine the server result and the local result to remove a contribution of the public input content from the server result, thereby resulting in a final output to the private input content.

25. The non-transitory computer-readable medium of claim 24, further comprising instructions of the mix algorithm that, when executed by the one or more hardware processors of the client device, cause the client device to perform operations including to append the final output to the private input content and repeat the mix, send, receive, process, combine, and append until an end of output token is reached.

26. The non-transitory computer-readable medium of claim 24, wherein the mix of the private input content with the public input content includes using a hyperparameter a that controls, at a word embedding level, how much weight is given to the private input content versus the public input content.

27. The non-transitory computer-readable medium of claim 26, wherein the mix of the private input content with the public input content includes the addition and/or multiplication, to the output, of noise according to a probability distribution to preclude attempts to reverse the mixing.

28. The non-transitory computer-readable medium of claim 27, wherein the noise is distributed according to a Gaussian distribution.

29. The non-transitory computer-readable medium of claim 27, wherein the noise is distributed according to a uniform distribution.

30. The non-transitory computer-readable medium of claim 24, wherein to combine includes to subtract the local result from the server result utilizing a hyperparameter 3 that adjusts an influence of the local result on the server result.

31. The non-transitory computer-readable medium of claim 24, wherein to combine includes to perform an argmax operation to utilize token with highest logits.

32. The non-transitory computer-readable medium of claim 24, further comprising instructions of the mix algorithm that, when executed by the one or more hardware processors of the client device, cause the client device to perform operations including to:
perform the mix, send, receive, process, and combine a plurality of times with different public input content and the same private input content; and
aggregate the results of the plurality of times to determine the final output, thereby increasing a possibility that tokens with largest logits after the aggregate are related the private input content.

33. The non-transitory computer-readable medium of claim 24, wherein the client device is a robot including one or more sensors configured to measure aspects of a condition of a computer-controlled machine and one or more actuators configured to control operation of the computer-controlled machine according to actuator control commands, and the non-transitory computer-readable medium further includes instructions of the mix algorithm that, when executed by the one or more hardware processors of the client device, cause the client device to perform operations including to:
receive the private input content from the one or more sensors; and
control the one or more actuators based on the actuator control command determined based on the final output.
